(19) United States
(12) Patent Application Publication
(10) Pub. No.: US 2025/0340430 A1
(43) Pub. Date: Nov. 6, 2025

(54) DEAERATION DEVICE

(71) Applicant: HEISHIN Ltd., Kobe-shi, Hyogo (JP)

(72) Inventors: Kenji NISHIMURA, Nagahama-shi, Shiga (JP); Nobuhisa SUHARA, Nagahama-shi, Shiga (JP); Eiji UETSUJI, Nagahama-shi, Shiga (JP); Goshi MORITA, Nagahama-shi, Shiga (JP); Noriaki SAKAKIHARA, Osaka-shi, Osaka (JP)

(73) Assignee: HEISHIN Ltd., Kobe-shi, Hyogo (JP)

(21) Appl. No.: 18/870,964

(22) PCT Filed: Apr. 10, 2023
(86) PCT No.: PCT/JP2023/014573

§ 371 Date: Dec. 2, 2024

(30) Foreign Application Priority Data
Jul. 19, 2022 (JP) 2022-114781

(51) Int. Cl. B67D 7/76

(52) U.S. Cl. CPC B67D 7/76

(57) ABSTRACT

A deaeration device includes: a channel forming member that defines an annular channel; an inlet port through which a fluid flows into the annular channel; an outlet port through which the fluid flows out of the annular channel; a partition that partially partitions the annular channel; an actuator that causes at least a part of the channel forming member to rotate relatively to the partition in the circumferential direction of the annular channel, to form a gradient in the pressure of the fluid in the annular channel; and an air vent that opens to the annular channel at a position where the pressure of the fluid is lower than the pressure of the fluid in the outlet port, and that releases the air bubbles contains in the fluid, to outside of the annular channel.

### TECHNICAL FIELD

The present invention relates to a deaeration device.

### BACKGROUND ART

In a system intermittently discharging a fluid from a dispenser, sometimes a deaeration device is provided to the feed channel for feeding the fluid in a tank into the dispenser. Patent Document 1 discloses a deaeration device including a gas-permeable tube forming a part of the feed channel, a housing airtightly housing the tube, and a decompressor pump for reducing the pressure inside the housing. The bubbles contained in the fluid pass through the tube, and are discharged into the low-pressure housing before getting into the dispenser.

### PRIOR ART DOCUMENT

### Patent Document

Patent Document 1: JP-A H11-156267

### SUMMARY OF THE INVENTION

### Problems to be Solved by the Invention

With the configuration described above, it is difficult to ensure the airtightness of the internal space of the housing. Moreover, a pump only for the use of deaeration is required. Such a requirement results in an increased complexity or size in the structure of the deaeration device.

An object of the present invention is to simplify the configuration of a deaeration device.

### Solutions to the Problems

A first aspect of the present invention provides a deaeration device including: an annular channel through which a fluid flows; a channel forming member that has an inner peripheral portion forming an inner peripheral side of the annular channel, an outer peripheral portion forming an outer peripheral side of the annular channel, and a pair of side walls forming respective axial sides of the annular channel, and defining the annular channel; an inlet port that is provided to the channel forming member, that opens to the annular channel, and through which the fluid flows into the annular channel; an outlet port that is provided to the channel forming member, that opens to the annular channel, and through which the fluid flows out of the annular channel; a partition that is provided in the channel forming member and partitions the annular channel in the circumferential direction; an actuator that causes at least one of the inner peripheral portion, the outer peripheral portion, and the pair of side walls to rotate relatively to the partition, in a circumferential direction of the annular channel, to form a gradient in pressure of the fluid in the annular channel; and an air vent that is provided to the channel forming member, that opens to the annular channel at a position where a pressure of the fluid is lower than the pressure of the fluid in the outlet port, and that releases air bubbles contained in the fluid, to outside of the annular channel.

As one can see from a well-known phenomenon that, when a liquid containing air bubbles is poured into a glass, the bubbles naturally rise to the water surface, bubbles contained in a fluid are naturally carried from a high-pressure side to a low-pressure side of the fluid. Using this principle, the deaeration device described above achieves deaeration with a simple configuration.

More specifically, the partition provides partitioning to the annular channel in the circumferential direction, so that the annular channel has a C-shape. The actuator rotates a part of the channel forming members defining the annular channel. The pressure of the fluid in the annular channel then comes to have a pressure gradient in which the pressure is higher on one side of the partition, and lower on the other side, in the circumferential direction. The fluid flows through the inlet port into the annular channel, and flows through the outlet port to the outside of the annular channel. The air vent opens to the annular channel at a position where the pressure of the fluid is lower than the pressure of the fluid in the outlet port. In a process in which the fluid flows through the annular channel, from the inlet port to the outlet port, air bubbles in the fluid are guided to the air vent that is on the low-pressure side, and are released to the outside of the annular channel.

In the manner described above, with a simple configuration of providing a partition to the annular channel and rotating a member defining the annular channel, it is possible to form a fluid pressure gradient inside the annular channel. In addition, with a simple configuration in which an air vent is provided to the low-pressure side, air bubbles are naturally carried to the air vent. Note that the actuator for rotating the member can be implemented using a configuration simpler than that of a pump applying a negative pressure to the chamber. Therefore, it is possible to simplify the configuration of the deaeration device.

### Effects of the Invention

According to the present invention, the configuration of the deaeration device can be simplified.

### BRIEF DESCRIPTION OF THE DRAWINGS

FIG. 1 is a conceptual diagram illustrating a dispensing system according to a first embodiment of the present invention.

FIG. 2 is a cross-sectional view of the deaerator according to the first embodiment.

FIG. 3 is a cross-sectional view of the deaerator according to the first embodiment taken along line III-III in FIG. 2.

FIG. 4 is a view illustrating a positional relationship between a pressure difference sensor and a rear liquid surface.

FIG. 5A is a functional diagram of a deaerator illustrating a stage of starting feeding the fluid.

FIG. 5B is a functional diagram of the deaerator illustrating a stage of filling the fluid.

FIG. 5C is a functional diagram of the deaerator exhibiting a steady operation.

FIG. 6 is a cross-sectional view of a deaerator according to a second embodiment.

FIG. 7 is a cross-sectional view of the deaerator according to the second embodiment, taken along line VII-VII in FIG. 6.

FIG. 8 is a cross-sectional view of a deaerator according to a third embodiment.

FIG. 9 is a cross-sectional view of a deaerator according to a fourth embodiment.

FIG. 10 is a cross-sectional view of a deaerator according to a fifth embodiment.

FIG. 11 is a cross-sectional view of a deaerator according to a sixth embodiment.

FIG. 12 is a cross-sectional view of the deaerator according to the sixth embodiment, taken along line XII-XII in FIG. 11.

FIG. 13 is a cross-sectional view of a deaerator according to a seventh embodiment.

### DETAILED DESCRIPTION

Embodiments of the present invention will now be explained with reference to drawings.

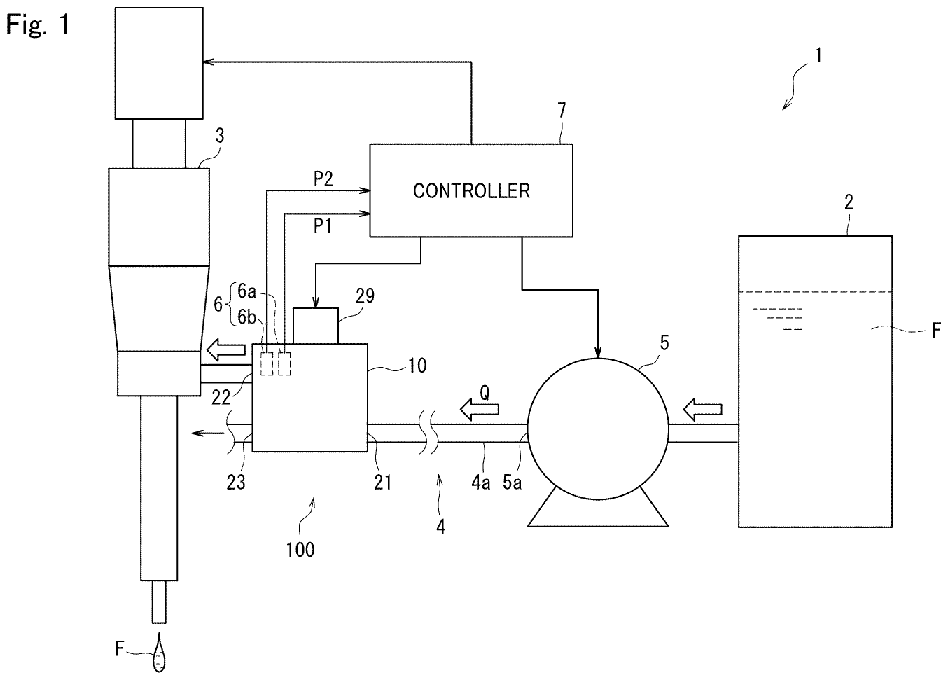

Referring to FIG. 1, a dispensing system 1 according to a first embodiment is deployed in a manufacturing site, such as an electronic component assembly factory or a food factory, for the purpose of intermittently discharging a fluid F toward a target. The fluid F may be any object other than gas, as long as the object can flow with a pressure gradient, as will be described later. The fluid F is not limited to a liquid such as water or oil, and may be a sol-like or gel-like flowable object such as a sealant, a coating liquid, mayonnaise, or fish paste.

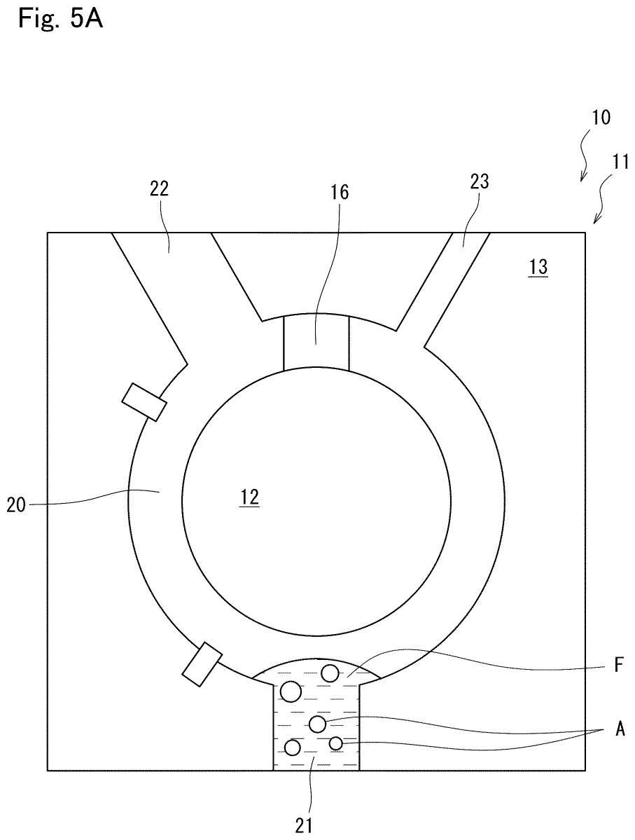

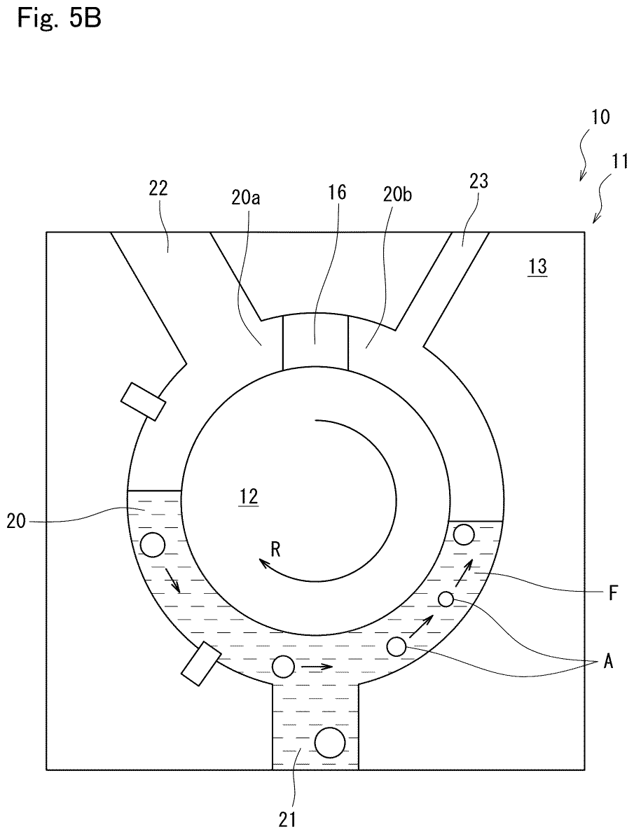

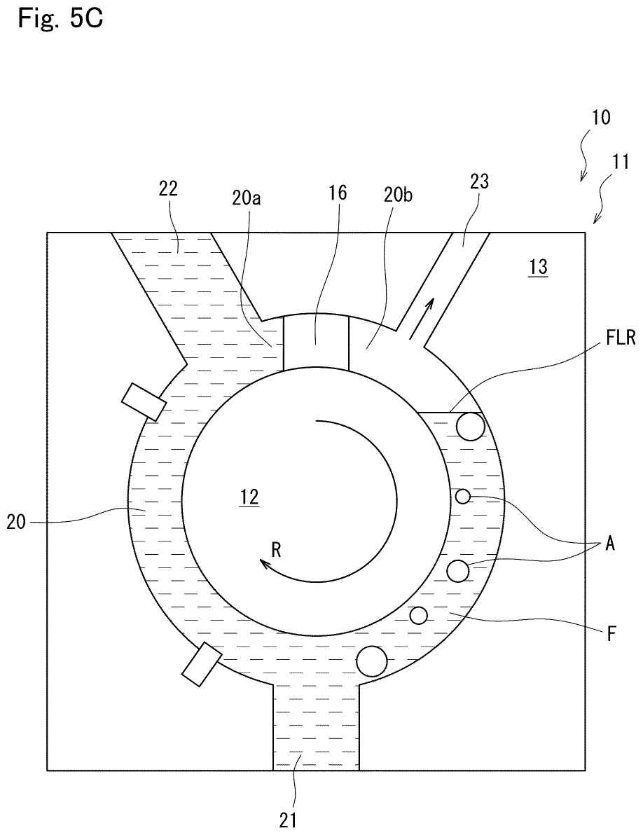

The dispensing system 1 includes a tank 2, a dispensing unit 3, a feed channel 4, a feeder pump 5, and a deaerator 10. The tank 2 stores therein the fluid F. There are times that air bubbles A (see FIG. 5A) become mixed in the fluid F stored in the tank 2. The dispensing unit 3 intermittently discharges the fluid F. The dispensing unit 3 may have any form as long as the dispensing unit 3 can repeat dispensing and stopping dispensing the fluid F alternately. Examples of the dispensing unit 3 include a dispenser, an on-off valve, or a pump (e.g., a uniaxial eccentric screw pump or a plunger pump). The feed channel 4 feeds the fluid F inside the tank 2 to the dispensing unit 3. The feeder pump 5 and the deaerator 10 are disposed in the feed channel 4 in the order listed herein, from the upstream side of the feed channel 4. The feeder pump 5 suctions the fluid F inside the tank 2, and pressure-feeds the fluid F through a dispensing port 5a. A dispensing line 4a forming a part of the feed channel 4 fluidly connects the dispensing port 5a to the deaerator 10. The deaerator 10 removes the air bubbles A from the fluid F. With this, the dispensing unit 3 can dispense the fluid F not containing any air bubbles A. The dispensing system 1 contributes to the improvement in the quality of products manufactured in the manufacturing site where the dispensing system 1 is deployed.

The deaerator 10 is installed on an installation target such as a floor surface of the manufacturing site, or on the dispensing unit 3 or the feeder pump 5, for example. The deaerator 10 may feed the fluid F into the dispensing unit 3 directly, as in the example illustrated, or may supply the fluid F into a cartridge, not illustrated, detachably attached to the dispensing unit 3.

The dispensing system I includes a deaeration device 100. The deaeration device 100 includes a pressure difference sensor 6 and a controller 7, as well as the deaerator 10. The feeder pump 5 and the feed channel 4 (in particular, the dispensing line 4a) may also be included in the deaeration device 100.

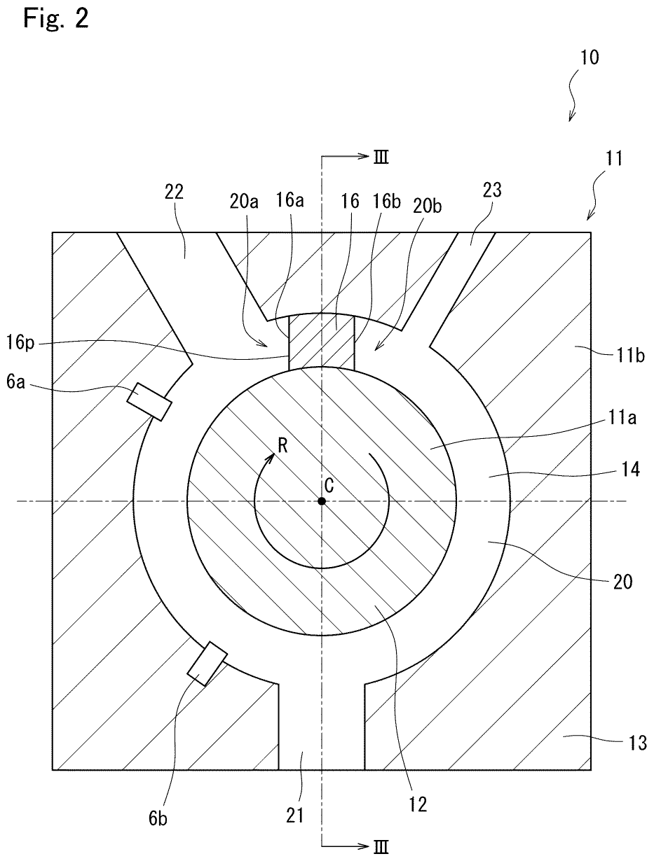

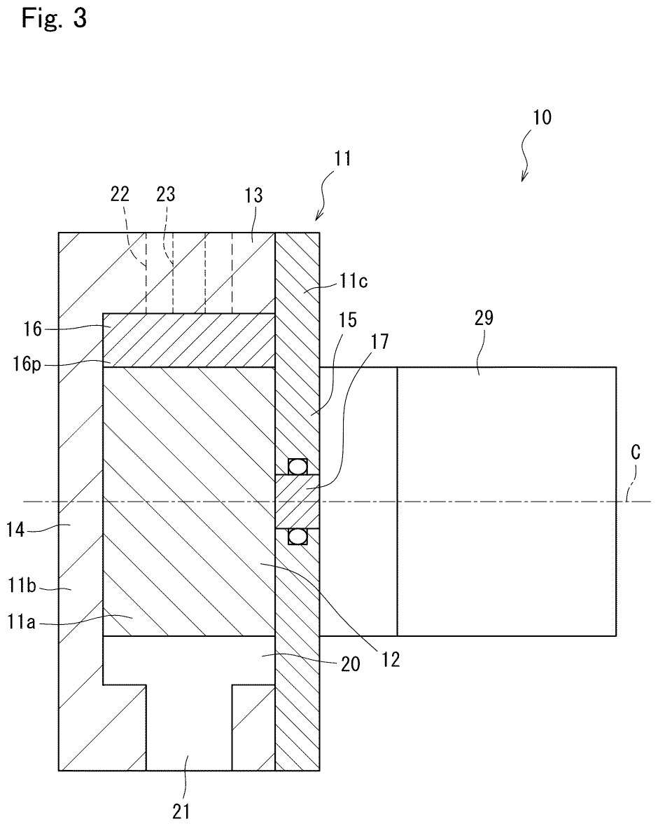

Referring to FIGS. 2 and 3, the deaerator 10 includes a channel forming member 11, an annular channel 20, an inlet port 21, an outlet port 22, an air vent 23, and an actuator 29.

The channel forming member 11 defines the annular channel 20 through which the fluid F flows. The channel forming member 11 includes an inner peripheral portion 12 forming the inner peripheral side of the annular channel 20, an outer peripheral portion 13 forming the outer peripheral side of the annular channel 20, a first side wall 14 and a second side wall 15 (a pair of side walls) disposed on the axial sides of the annular channel 20, respectively, and a partition 16 that partitions the annular channel 20 in the circumferential direction. These four sections, which are the inner peripheral portion 12, the outer peripheral portion 13, the first side wall 14, and the second side wall 15, are provided to a plurality of respective separate parts. The channel forming member 11 is formed of a set of the plurality of these parts. The partition 16 is provided to one of the parts in the set forming the channel forming member 11, and is integrated with one of these four sections.

The inlet port 21, the outlet port 22, and the air vent 23 are provided to the channel forming member 11, and open to the annular channel 20. The inlet port 21 permits the fluid F to flow into the annular channel 20. The outlet port 22 permits the fluid F to flow out of the annular channel 20. Through the air vent 23, the air bubbles A (see FIG. 5A) contained in the fluid F (see FIG. 5A) are released outside of the annular channel 20.

The actuator 29 drives to cause at least one of the inner peripheral portion 12, the outer peripheral portion 13, and the pair of side walls 14, 15 to rotate, along a predetermined rotational direction R around a central axis C, in the circumferential direction of the annular channel 20. The actuator 29 includes an electric motor, for example.

In this embodiment, the channel forming member 11 is composed of three parts of an inner member 11a, a first outer member 11b, and a second outer member 11c. The inner member 11a has a columnar shape, and provides the inner peripheral portion 12. The first outer member 11b has a bottomed tubular shape, and integrally provides the outer peripheral portion 13 and the first side wall 14. The second outer member 11c has a plate-like shape, and provides the second side wall 15. By housing the inner member 11a inside the space closed by the first outer member 11b and the second outer member 11c, the annular channel 20 is formed. In this embodiment, the actuator 29 drives to cause the inner peripheral portion 12 to rotate. The inner member 11a is a rotating body that is driven in rotation by the actuator 29. The first outer member 11b and the second outer member 11c together form a fixed body that is fixed to the installation target, and is not driven in rotation by the actuator 29. The partition 16 as well as the inlet port 21, the outlet port 22, and the air vent 23 are provided to the fixed body.

The first outer member 11b has an inner space defined by the inner surface of the first side wall 14 and the inner peripheral surface of the outer peripheral portion 13. The inner peripheral surface of the outer peripheral portion 13 has a perfect circular cross section having the center at the central axis C. The inner surface is perpendicular to the central axis C. The inner member 11a is housed in the inner space of the first outer member 11b. The inner member 11a has a cylindrical shape or a shaft shape, and is disposed coaxially with the first outer member 11b. The outer peripheral surface of the inner peripheral portion 12 has a perfect circular cross section. The second outer member 11c is joined to an axial end surface of the outer peripheral portion 13, with the inner member 11a housed inside the first outer member 11b, and closes the inner space of the first outer member 11b. The inner peripheral portion 12 has an axial length slightly shorter than that of the outer peripheral portion 13. End surfaces of the inner peripheral portion 12 are in sliding contact with, or face closely the inner side surfaces of the pair of side walls 14, 15, respectively.

The outer peripheral surface of the inner member 11a (that is, the outer peripheral surface of the inner peripheral portion 12) has a smaller diameter than that of the inner peripheral surface of the first outer member 11b (that is, the inner peripheral surface of the outer peripheral portion 13). The annular channel 20 is defined by the outer peripheral surface of the inner peripheral portion 12, the inner peripheral surface of the outer peripheral portion 13, and the inner side surfaces of the pair of respective side walls 14, 15. The annular channel 20 has an annular shape in a view in the axial direction, and has a channel width corresponding to the difference in the radius of the inner peripheral surface and the outer peripheral surface. The cross-sectional shape of the annular channel 20 remains constant in the axial direction.

The actuator 29 is attached to the outer surface of the outer members 11b,11c, each of which is a fixed body, specifically, the outer surface of one of the side walls 14, 15 (the second side wall 15 in this embodiment). The inner member 11a has a transmission shaft 17 protruding from an end surface of the inner peripheral portion 12, and the transmission shaft 17 is supported rotatably by the second side wall 15, where the actuator 29 is attached. The rotational driving force generated by the actuator 29 is transmitted to the transmission shaft 17. The inner peripheral portion 12 rotates integrally with (rotates about) the transmission shaft 17, in a predetermined rotational direction R about the central axis C.

The partition 16 projects out from the inner peripheral surface of the outer peripheral portion 13 into the annular channel 20. A projecting end 16p of the partition 16 has a concave surface having the same curvature radius as the outer peripheral surface of the inner member 11a, and is in sliding contact with or disposed closely facing the outer peripheral surface of the inner member 11a. The partition 16 serves as a partitioning wall provided to a part of the annular channel 20 in the circumferential direction. The partition 16 extends in the axial direction. One end of the partition 16 is integrated with the inner surface of the first side wall 14. The other end of the partition 16 is in contact with or disposed closely facing the inner surface of the second side wall 15.

In FIG. 2, the rotational direction R of the inner member 11a that is a rotating body is represented by an arc-shaped arrow drawn across an angular range not provided with the partition 16. The side of the head of this arrow (the forward in the rotating motion) will be referred to as a “forward side” with respect to the rotational direction R, and the side of the base of the arrow shaft (the side opposite to the forward side in the rotating motion) will be referred to as a “rearward side” with respect to the rotational direction R. The annular channel 20 extends, from a first end 20a to a second end 20b, in a C shape, in the direction extending oppositely to the rotational direction R in a view in the axial direction. The partition 16 sits between the first end 20a and the second end 20b of the annular channel 20, in the circumferential direction. The annular channel 20 is also defined by a first surface 16a of the partition 16 and a second surface 16b of the partition 16. As illustrated, considering that the partition 16 provided to the fixed body is at a position of 12 o′clock and the rotational direction R is clockwise, the first surface 16a and the first end 20a are on the left side of the partition 16, and the second surface 16b and the second end 20b are on the right side of the partition 16. With the configuration described above, the fluid F is substantially not allowed to pass from the first end 20a to the second end 20b of the annular channel 20, across the partition 16.

The inlet port 21, the outlet port 22, and the air vent 23 open to the annular channel 20. These three ports are provided on the outer peripheral portion 13 of the first outer member 11b, and open to the outer surface and the inner peripheral surface of the outer peripheral portion 13. The inlet port 21 is connected to the dispensing line 4a (see FIG. 1), and permits the fluid F having been fed by the feeder pump 5 to flow into the annular channel 20. The air vent 23 releases the air bubbles A contained in the fluid F to the outside of the annular channel 20. The air vent 23 opens to the atmosphere, and releases the air bubbles A to the atmosphere. Through the outlet port 22, the fluid F having the air bubbles A removed flows out of the annular channel 20.

The outlet port 22 opens to the first end 20a. The air vent 23 opens to the second end 20b. The inlet port 21 is provided between the outlet port 22 and the air vent 23 in the circumferential direction. The inlet port 21 opens to the annular channel 20 at a position opposite to the partition 16 in the diametrical direction.

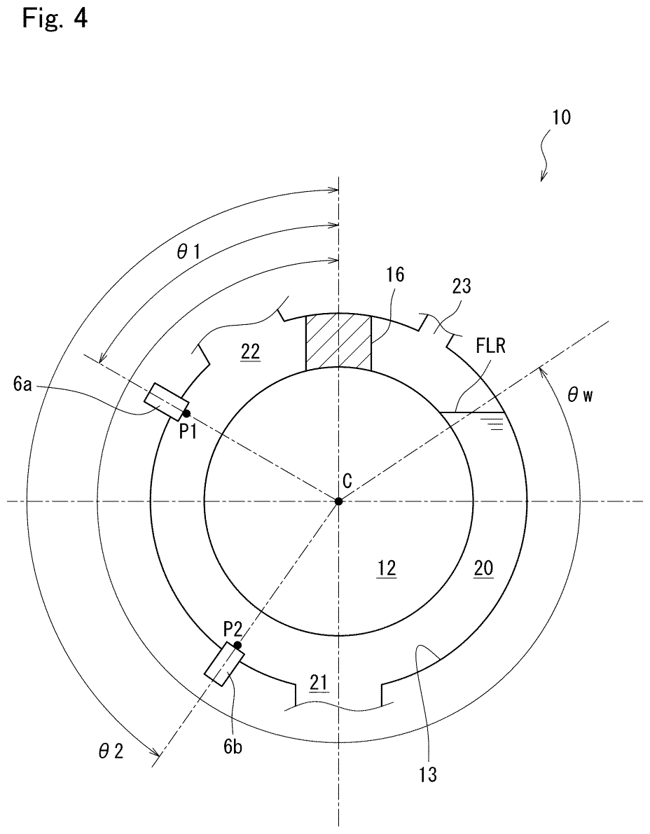

Referring to FIG. 4, the pressure difference sensor 6 detects a pressure difference between two points in the annular channel 20. The pressure difference sensor 6 may be implemented as a single sensor that detects a gauge pressure with respect to a reference pressure, or may be implemented as two sensors that detect pressures at two respective points. In this embodiment, the pressure difference sensor 6 includes two sensors that are a first pressure sensor 6a and a second pressure sensor 6b, and the pressure difference is calculated from the detection results of these two sensors.

The first pressure sensor 6a is installed at a first detection point circumferentially spaced apart from the partition 16 in the counterclockwise direction (in the direction opposite to the rotational direction R), by a first installation angle θ1. The first pressure sensor 6a detects a first pressure P1 that is a pressure of the fluid F at the first detection point. The second pressure sensor 6b is installed at a second detection point circumferentially spaced apart from the partition 16 in the counterclockwise direction, by a second installation angle θ2. The second pressure sensor 6b detects a second pressure P2 that is a pressure of the fluid F at the second detection point. The second installation angle θ2 is greater than the first installation angle θ1. In this embodiment, as a mere example, the first installation angle θ1 is 60 degrees, and the second installation angle θ2 is 150 degrees. The first installation angle θ1 and the second installation angle θ2 are set within an angular range between the positions of the inlet port 21 of the annular channel 20 and the first surface 16a of the partition 16.

Returning to FIG. 1, the controller 7 is connected to the pressure difference sensor 6 (the first pressure sensor 6a and the second pressure sensor 6b), the actuator 29, and the feeder pump 5. The controller 7 may also be connected to the dispensing unit 3. The controller 7 controls to cause the actuator 29 to drive a rotating body (in this embodiment, the inner member 11a) in rotation, during the operation of the deaeration device 100. The controller 7 controls the position of the liquid surface of the fluid F in the annular channel 20 on the basis of the pressure difference detected by the pressure difference sensor 6. In order to control the position of the liquid surface, the controller 7 controls a flow rate Q of the feeder pump 5, as an example.

An operation of the deaeration device 100 will now be explained. Before starting the deaeration device 100, the annular channel 20, the inlet port 21, and the outlet port 22 are empty. Once the deaeration device 100 is started, the feeder pump 5 starts to operate, and feeds the fluid F into the deaerator 10. The actuator 29 also starts to operate, and drives the inner member 11a as a rotating body in rotation. The pressure and the flow rate at which the feeder pump 5 discharges the fluid F, and the speed of the rotation of the rotating body are adjusted as appropriate, in a manner suitable to the properties (such as viscosity) of the fluid F.

As illustrated in FIG. 5A, when the deaeration device 100 is started, the fluid F containing the air bubbles A is supplied by the feeder pump 5 (see FIG. 1), through the dispensing line 4a (see FIG. 1), and into the inlet port 21. FIG. 5B illustrates a stage of the process in which the fluid F is filled in the annular channel 20. The liquid surface of the fluid F in the annular channel 20 has reached neither the outlet port 22 nor the air vent 23 yet.

The fluid F introduced into the annular channel 20 is dragged along the outer peripheral surface near the part where the fluid F comes into contact with the outer peripheral surface of the inner member 11a that is a rotating body, due to the viscous friction generated between the fluid F and the outer peripheral surface. As a result, the fluid F in the annular channel 20 comes to have a pressure gradient with a higher pressure on the forward side in the rotational direction R (with a lower pressure on the rearward side in the rotational direction R). The air bubbles A contained in the fluid F are thus carried from the high-pressure side to the low-pressure side of the fluid F. In other words, the air bubbles A are naturally carried rearwards in the positive direction R.

The rear liquid surface FLR of the fluid F comes into contact with the atmosphere via the second end 20b and the air vent 23 of the annular channel 20. Therefore, the pressure on the rear liquid surface FLR is substantially equal to the atmospheric pressure. This pressure allows the air bubbles A carried to the rear liquid surface FLR to escape from the fluid F, and to be released to the atmosphere through the air vent 23.

FIG. 5C illustrates a state in which the annular channel 20 is filled with the fluid F, with the deaerator 10 in the steady operation. In the same principle as described above, a pressure gradient is formed in the fluid F inside the annular channel 20. On the forward side in the rotational direction R with respect to the inlet port 21, the fluid F is fully filled to a level where the fluid F is in contact with the first surface 16a of the partition 16. The outlet port 22 opens to the first end 20a where the first surface 16a confronts. That is, the outlet port 22 is provided to the part of the annular channel 20 where the pressure of the fluid F is the highest, as much as possible. The fluid F with a relatively high pressure flows out through the outlet port 22 smoothly.

By contrast, on the rearward side in the rotational direction R with respect to the inlet port 21, the fluid F has not reached the second surface 16b of the partition 16, and the rear liquid surface FLR is exposed inside the annular channel 20. Therefore, during the steady operation, too, the air bubbles A having been carried to the rear liquid surface FLR come out of the fluid F, and are released into the atmosphere through the air vent 23, following the same principle as described above.

As described above, with the deaeration device 100 according to this embodiment, with a simple configuration in which the annular channel 20 is partially partitioned in the circumferential direction, in which a part of the channel forming member 11 (in this embodiment, the inner peripheral portion 12) defining the annular channel 20 is rotated relatively to the partition 16, and in which the air vent 23 is provided on the side with a pressure lower than that in the outlet port 22, it is possible to form a pressure gradient in the fluid F inside the annular channel 20, so that the air bubbles A are naturally carried toward the air vent 23. Even with the deaerator 10 with a device requiring higher airtightness such as a vacuum chamber omitted, sufficient deaeration effect can be achieved. Furthermore, by using the actuator 29 configured to generate a rotational driving force, the structure can be simplified, compared with a structure using an actuator (vacuum pump) that applies a negative pressure to the internal of the chamber. As a result, the configuration of the deaeration device 100 can be simplified.

The outlet port 22 opens to the first end 20a that is on the high-pressure side of the annular channel 20 defined by the partition 16, and the air vent 23 opens to the second end 20b on the low-pressure side that is on the opposite side of the high-pressure side with the partition 16 of the annular channel 20 disposed therebetween. The outlet port 22 is not only physically separated from the air vent 23, but also separated in terms of the pressure difference, as far as possible. Therefore, it is possible to reduce the chances of leakage of the air bubbles A contained in the fluid F through the outlet port 22.

The inlet port 21 opens to the annular channel 20 at a position where the pressure of the fluid F is lower than that in the outlet port 22, and where the pressure of the fluid F is higher than that in the air vent 23. The outlet port 22 and the air vent 23 are disposed at positions opposing to each other with respect to the inlet port 21. Therefore, it is possible to reduce the chances of leakage of the air bubbles A contained in the fluid F through the outlet port 22.

The inner peripheral surface of the outer peripheral portion 13 defining the annular channel 20 and the outer peripheral surface of the inner peripheral portion 12 each delineate a perfect circle. Therefore, the air bubbles A are not caught on the inner peripheral portion 12 or on the outer peripheral portion 13, and are smoothly carried through the annular channel 20 to the rear liquid surface FLR.

Referring to FIG. 4, if the pressure or the flow rate at which the feeder pump 5 discharges the fluid F is too high, the rear liquid surface FLR may rise and the fluid F may leak through the air vent 23 to the atmosphere. The controller 7 therefore controls, during the steady operation, the position of the rear liquid surface FLR so as to prevent such leakage of the fluid F.

Specifically, the controller 7 estimates the position of the rear liquid surface FLR, specifically, a counterclockwise angle θw from the partition 16 to the rear liquid surface FLR, on the basis of following Equation (1).

$$θ w ≡ P 2 \times ( θ2 - θ1 ) / ( P 1 - P 2 ) + θ 2 \qquad ( 1 )$$

Where P1 is a detection of the first pressure sensor 6a, and P2 is a detection of the second pressure sensor 6b.

The controller 7 then compares the estimation of the angle θw of the rear liquid surface FLR with a set value. The set value is set to an angle from the partition 16 to a position near the air vent 23 in the annular channel 20. When this estimation becomes greater than the set value, the operation of the feeder pump 5 is controlled to reduce the flow rate Q of the fluid F being discharged from the feeder pump 5. In this manner, leakage of the fluid F can be prevented.

In this embodiment, the outer peripheral surface and the inner peripheral surface each having a true circular cross section are positioned concentrically. Because the channel width of the annular channel 20 remains constant across the entire circumferential direction, a substantially linear pressure gradient is obtained. Therefore, the position of the liquid surface can be estimated accurately, and the position of the liquid surface can be controlled accurately.

A second embodiment of the present invention will now be explained, focusing on the differences with respect to the embodiment described above.

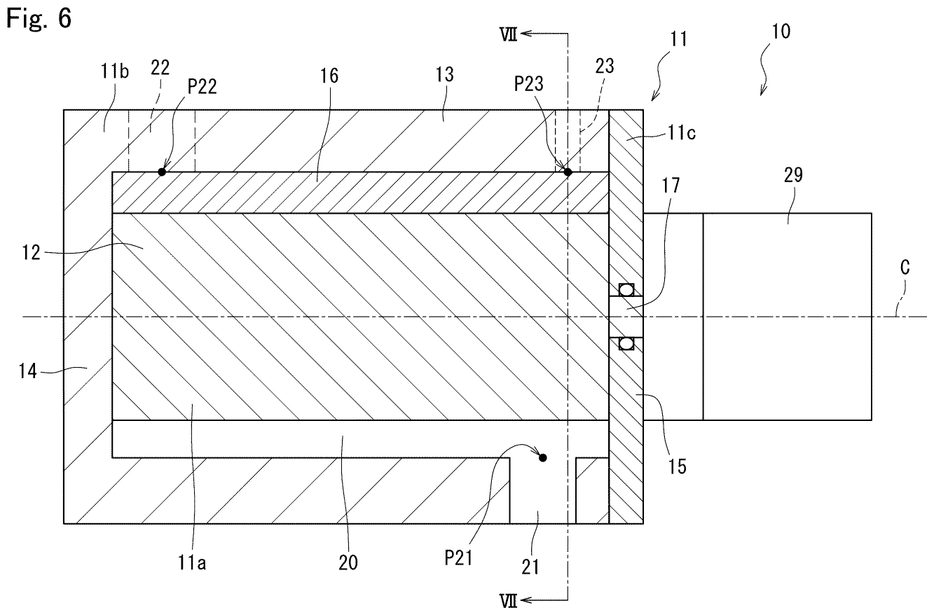

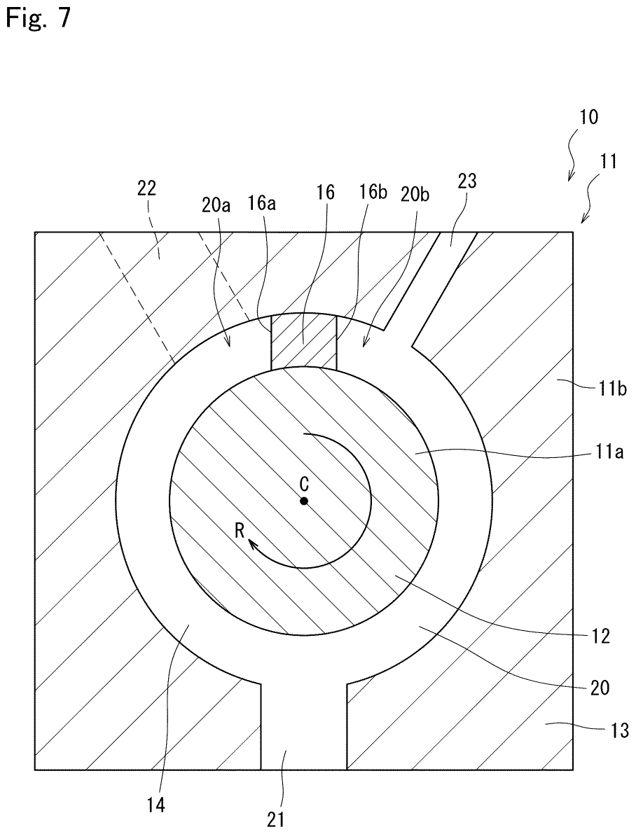

Referring to FIGS. 6 and 7, also in the deaerator 10 according to this embodiment, the inner member 11a forms the inner peripheral portion 12; the first outer member 11b forms the outer peripheral portion 13 and the first side wall 14; the second outer member 11c forms the second side wall 15; and the actuator 29 drive to cause the inner peripheral portion 12 to rotate, in the same manner as in the first embodiment. The inner member 11a is a rotating body, and the first outer member 11b and the second outer member 11c together form a fixed body. The partition 16 as well as the inlet port 21, the outlet port 22, and the air vent 23 are provided to the fixed body.

In this embodiment, the inner peripheral portion 12, the outer peripheral portion 13, and the annular channel 20 are longer in the axial direction than that in the first embodiment. In the first embodiment, because the annular channel 20 is shorter in the axial direction, the inlet port 21, the outlet port 22, and the air vent 23 are at the same position in the axial direction (see FIG. 3). By contrast, in this embodiment, the outlet port 22 and the air vent 23 are separated from each other in the axial direction of the annular channel 20. The inlet port 21 is nearer to the air vent 23 than the outlet port 22, in the axial direction of the annular channel 20. The inlet port 21 and the air vent 23 open to one end of the annular channel 20. The outlet port 22 opens to the other axial end of the annular channel 20.

The air vent 23 is positioned offset from the area provided with the outlet port 22, in the axial direction. The positional relationship of these three ports in the circumferential direction is the same as that in the first embodiment. The pressure of the fluid in the annular channel 20 becomes higher forwards in the rotational direction R, along the circumferential direction. Therefore, the pressure P21 in the inlet port 21, the pressure P22 in the outlet port 22, and the pressure P23 in the air vent 23 satisfy the relationship P22>P21>P23.

Hence, in this embodiment, too, the configuration of the deaeration device 100 can be simplified, in the same manner as in the first embodiment. In addition, in this embodiment, because the outlet port 22 is spaced apart from the inlet port 21 also in the axial direction, it takes a longer time for the fluid F to pass through the annular channel 20. Therefore, the air bubbles A are guided to the air vent 23, as the fluid F flows toward the outlet port 22, over a longer time. In this manner, it is possible to further reduce the chance of leakage of the air bubbles A from the outlet port 22.

A third embodiment of the present invention will now be explained, focusing on the differences with respect to the embodiments described above.

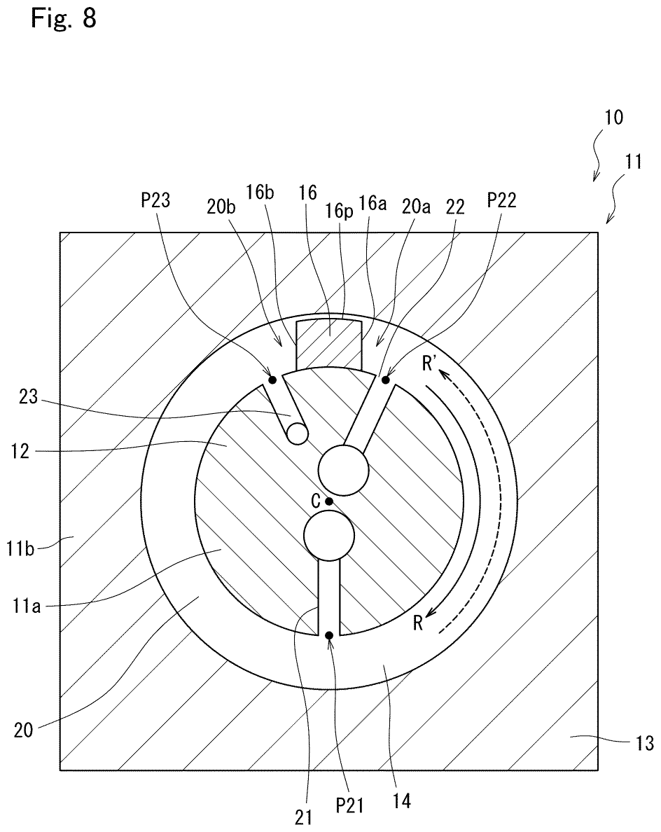

Referring to FIG. 8, also in the deaerator 10 according to this embodiment, the inner member 11a forms the inner peripheral portion 12, and the first outer member 11b forms the outer peripheral portion 13 and the first side wall 14, in the same manner as in the first embodiment. Although not illustrated in detail, the second outer member is disposed nearer to the paper surface in FIG. 8, and forms the second side wall. The actuator 29 drives to cause the inner peripheral portion 12 to rotate. The inner member 11a is a rotating body, and the first outer member 11b and the second outer member together form a fixed body. The axial direction is the same as that of the first embodiment.

In this embodiment, unlike the first and second embodiments, the partition 16 as well as the inlet port 21, the outlet port 22, and the air vent 23 are provided to the inner member 11a configured as a rotating body. The partition 16 projects out from the outer peripheral surface of the inner peripheral portion 12 into the annular channel 20. A projecting end 16p of the partition 16 has a convex surface having the same curvature radius as the inner peripheral surface of the outer peripheral portion 13, and is in sliding contact with or disposed closely facing the outer inner surface. Ends of the partition 16 are flush with the respective end surfaces of the inner peripheral portion 12, and are in sliding contact with or disposed closely facing the inner side surfaces of the first side wall 14 and the second side wall, respectively.

In this embodiment, the low-pressure side is on the forward side in the rotational direction R. of the inner member 11a, and the high-pressure side is on the rearward side. Using the partition 16 as a reference, the first outer member 11b rotates relatively to the inner member 11a, in a direction R′ that is opposite to the rotational direction R. In the direction of this relative rotation (reverse direction R′) of the first outer member 11b with respect to the inner member 11a, the high-pressure side comes to the forward side, and the low-pressure side comes to the rearward side, with reference to the partition 16. The first surface 16a of the partition 16 and the first end 20a of the annular channel 20 are located on the forward side in the direction of the relative rotation (reverse direction R′). The second surface 16b of the partition 16 and the second end 20b of the annular channel 20 are located on the rearward side in the direction of the relative rotation (reverse direction R′). As the inner member 11a is rotated, the pressure of the fluid F becomes lower in the direction from the first end 20a toward the second end 20b.

The inlet port 21 opens to the annular channel 20 at a position in the middle between the first end 20a (first surface 16a) and the second end 20b (second surface 16b) in the circumferential direction, and at the position opposite to the partition 16 in the diametrical direction. The outlet port 22 opens to the first end 20a, and the air vent 23 opens to the second end 20b. The pressure P21 in the inlet port 21, the pressure P22 in the outlet port 22, and the pressure P23 in the air vent 23 satisfy the relationship P22>P21>P23.

Hence, in this embodiment, too, the configuration of the deaeration device 100 can be simplified, in the same manner as in the first embodiment.

A fourth embodiment of the present invention will now be explained, focusing on the differences with respect to the embodiments described above.

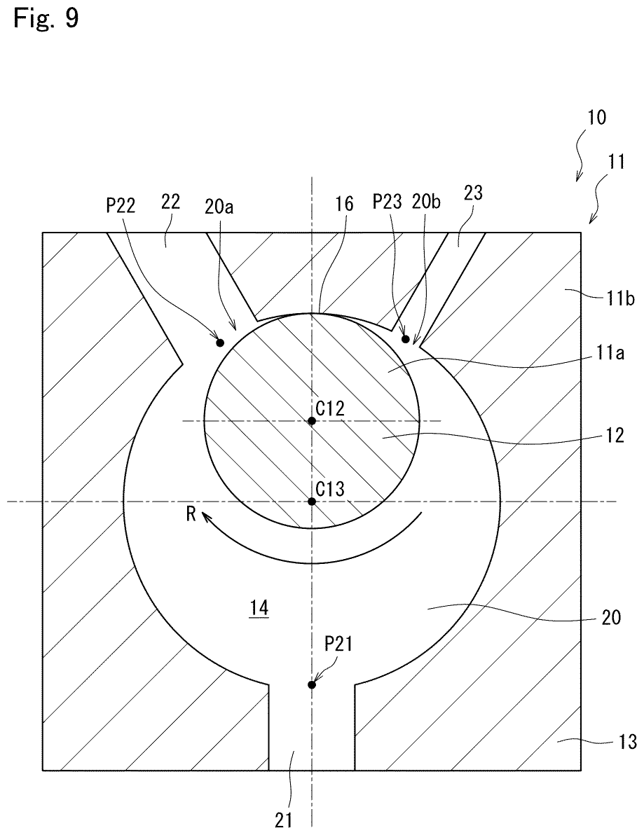

Referring to FIG. 9, also in the deaerator 10 according to this embodiment, the inner member 11a forms the inner peripheral portion 12, and the first outer member 11b forms the outer peripheral portion 13 and the first side wall 14, in the same manner as in the first embodiment. Although not illustrated in detail, the second outer member is disposed nearer to the paper surface in FIG. 9, and forms the second side wall. The actuator 29 drives to cause the inner peripheral portion 12 to rotate. The inner member 11a is a rotating body, and the first outer member 11b and the second outer member together form a fixed body. The axial direction is the same as that of the first embodiment.

In this embodiment, the center C12 of the inner peripheral portion 12 is offset from the center C13 of the outer peripheral portion 13. An outer peripheral surface of the inner peripheral portion 12 is in contact with an inner peripheral surface of the outer peripheral portion 13. The partition 16 is not a partitioning wall as in the previous embodiments, but is formed by this contact, and is provided to the rotating body. Because the inner peripheral portion 12 is positioned off the center, a C shape is delineated by the annular channel 20. With the partition 16 as a reference, the high-pressure side is on the forward side in the rotational direction R of the inner peripheral portion 12, and the low-pressure side is on the rearward side in the rotational direction R. The C-shaped annular channel 20 has the first end 20a on the forward side in the rotational direction R of the inner peripheral portion 12, with respect to the partition 16. The C-shaped annular channel 20 has the second end 20b on the rearward side in the rotational direction R of the inner peripheral portion 12, with respect to the partition 16. The pressure of the fluid F decreases from the first end 20a toward the second end 20b.

Although the partition 16 is provided to the rotating body, because the position of the partition 16 in the circumferential direction with respect to the fixed body remains unchanged, the inlet port 21, the outlet port 22, and the air vent 23 are provided in the fixed body. The inlet port 21 has an opening at a position in the middle between the first end 20a and the second end 20b in the circumferential direction, and faces the partition 16 in the diametrical direction. The outlet port 22 opens to the first end 20a, and the air vent 23 opens to the second end 20b. The pressure P21 in the inlet port 21, the pressure P22 in the outlet port 22, and the pressure P23 in the air vent 23 satisfy the relationship P22>P21>P23.

Hence, in this embodiment, too, the configuration of the deaeration device 100 can be simplified, in the same manner as in the first embodiment.

A fifth embodiment of the present invention will now be explained, focusing on the differences with respect to the embodiments described above.

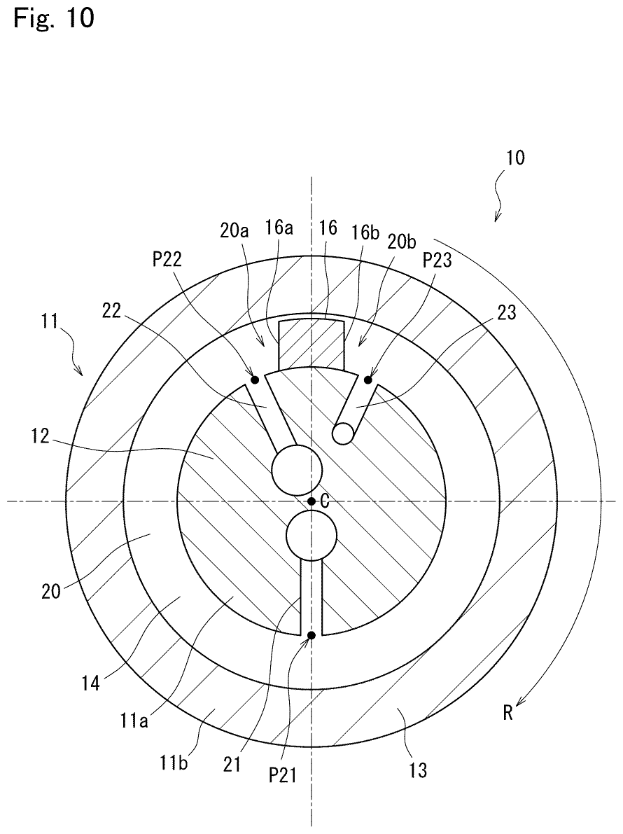

Referring to FIG. 10, also in the deaerator 10 according to this embodiment, the inner member 11a forms the inner peripheral portion 12, and the first outer member 11b forms the outer peripheral portion 13 and the first side wall 14, in the same manner as in the first embodiment. Although not illustrated in detail, the second outer member is disposed nearer to the paper surface in FIG. 10, and forms the second side wall. The axial direction is the same as that of the first embodiment.

In this embodiment, the actuator 29 drives at least the first outer member 11b in rotation, unlike in the first to fourth embodiments. The first outer member 11b is a rotating body, and the inner member 11a is a fixed body. The second outer member may be a fixed body or a rotating body, but it is assumed herein that the second outer member is a rotating body, as an example. The partition 16 as well as the inlet port 21, the outlet port 22, and the air vent 23 are provided to the inner member 11a that is a fixed body, in the same manner as in the third embodiment.

In this embodiment, the first surface 16a of the partition 16 and the first end 20a of the annular channel 20 are on the forward side in the rotational direction R of the first outer member 11b that is a rotating body. The second surface 16b of the partition 16 and the second end 20b of the annular channel 20 are on the rearward side in the rotational direction R. When the first outer member 11b is rotated, the fluid F is dragged by the inner peripheral surface of the outer peripheral portion 13, and the pressure of the fluid F becomes lower from the first end 20a toward the second end 20b.

The inlet port 21, the outlet port 22, and the air vent 23 are provided to the inner member 11a that is a fixed body. The inlet port 21 opens to the annular channel 20 at a position in the middle between the first end 20a (first surface 16a) and the second end 20b (second surface 16b) in the circumferential direction, and at the position opposite to the partition 16 in the diametrical direction. The outlet port 22 opens to the first end 20a, and the air vent 23 opens to the second end 20b. The pressure P21 in the inlet port 21, the pressure P22 in the outlet port 22, and the pressure P23 in the air vent 23 satisfy the relationship P22>P21>P23.

Hence, in this embodiment, too, the configuration of the deaeration device 100 can be simplified, in the same manner as in the first embodiment.

A sixth embodiment of the present invention will now be explained, focusing on the differences with respect to the embodiments described above.

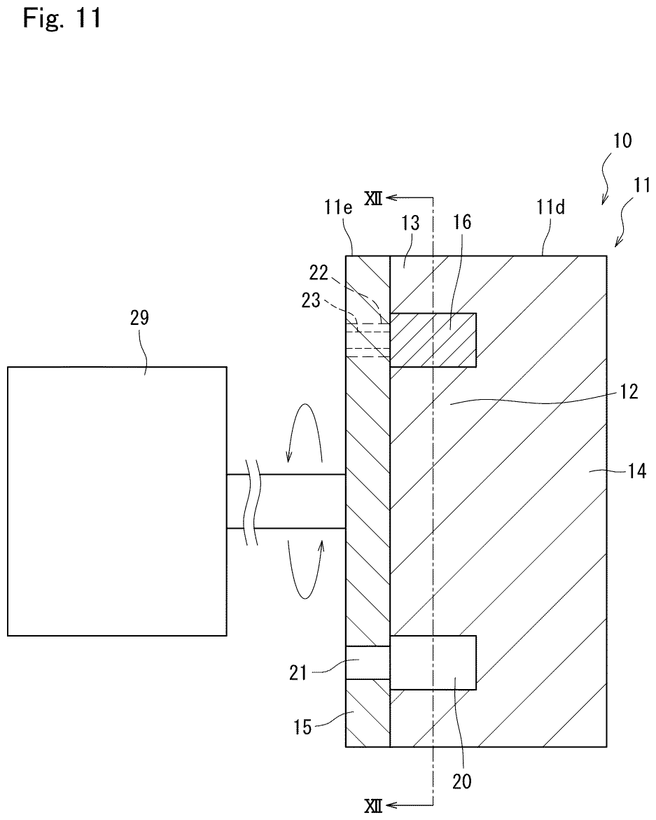

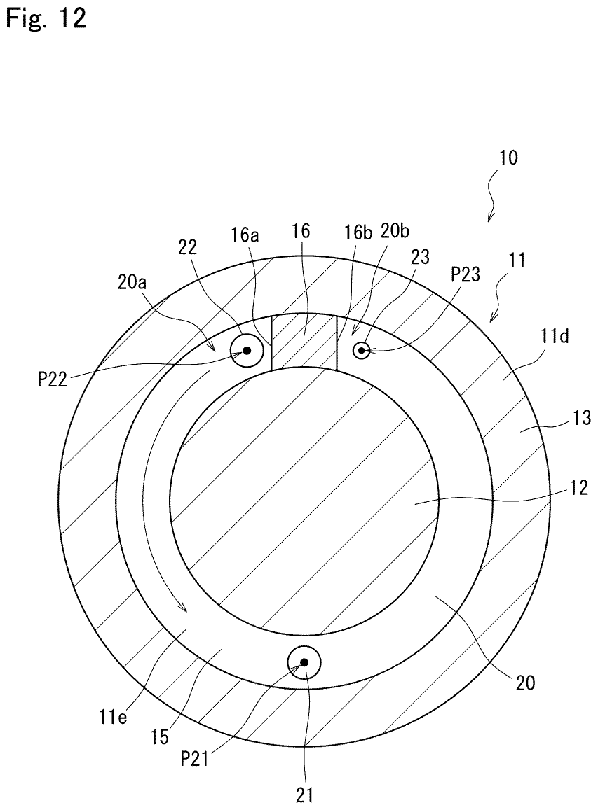

Referring to FIGS. 11 and 12, in the deaerator 10 according to this embodiment, the channel forming member 11 includes two parts, that is, a first member 11d and a second member 11e. The first member 11d includes an inner peripheral portion 12, an outer peripheral portion 13, and a first side wall 14 that are integrated with one another. The second member 11e provides the second side wall 15. The axial direction is the same as that of the first embodiment. The actuator 29 drives the second side wall 15 in rotation. The second member 11e is a rotating body, and the first member 11d is a fixed body. The partition 16 as well as the inlet port 21, the outlet port 22, and the air vent 23 are provided to the rotating body. The partition 16 protrudes in the axial direction from the inner surface of the second side wall 15, and is in sliding contact with or disposed closely facing the inner surface of the first side wall 14.

In this embodiment, the first surface 16a of the partition 16 and the first end 20a of the annular channel 20 are on the forward side in the rotational direction R of the second member 11e that is a rotating body. The second surface 16b of the partition 16 and the second end 20b of the annular channel 20 are on the rearward side in the rotational direction R. When the second member Ile is rotated, the fluid F is dragged by the inner surface of the second side wall 15 and pushed by the partition 16, and the pressure of the fluid F decreases from the first end 20a toward the second end 20b.

The inlet port 21 opens to the annular channel 20 at a position in the middle between the first end 20a (first surface 16a) and the second end 20b (second surface 16b) in the circumferential direction, and at the position opposite to the partition 16 in the diametrical direction. The outlet port 22 opens to the first end 20a, and the air vent 23 opens to the second end 20b. The pressure P21 in the inlet port 21, the pressure P22 in the outlet port 22, and the pressure P23 in the air vent 23 satisfy the relationship P22>P21>P23.

Hence, in this embodiment, too, the configuration of the deaeration device 100 can be simplified, in the same manner as in the first embodiment.

A seventh embodiment of the present invention will now be explained, mainly focusing on the differences with respect to the embodiments described above.

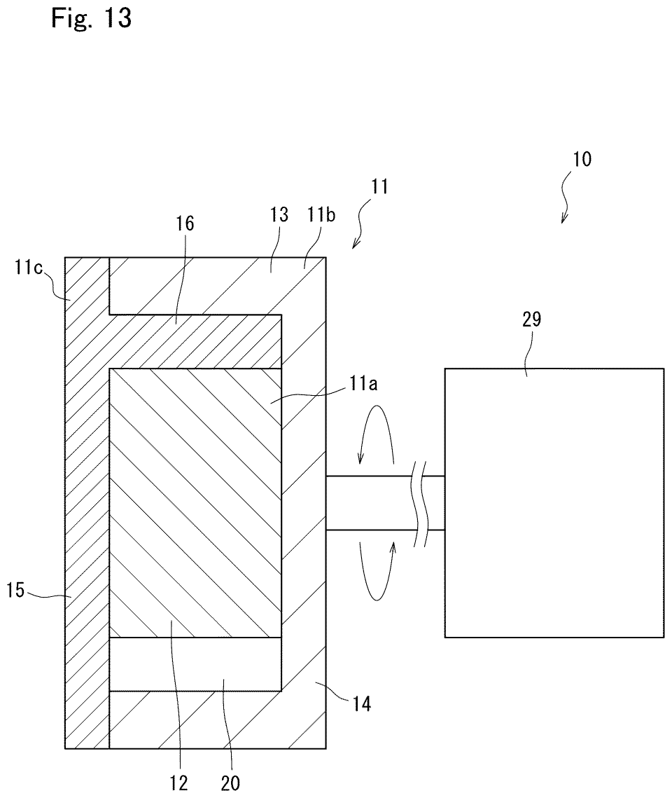

Referring to FIG. 13, also in the deaerator 10 according to this embodiment, the inner member 11a forms the inner peripheral portion 12, and the first outer member 11b forms the outer peripheral portion 13 and the first side wall 14, and the second outer member 11c forms the second side wall 15, in the same manner as in the fifth embodiment. The axial direction is the same as that of the first embodiment. The actuator 29 drives at least the first outer member 11b in rotation. The first outer member 11b is a rotating body, and the inner member 11a and the second outer member 11c together form a fixed body.

In this embodiment, the partition 16 is provided on the second outer member 11c that is a fixed body. The partition 16 protrudes in the axial direction from the inner surface of the second side wall 15, and is in sliding contact with or disposed closely facing the inner surface of the first side wall 14. In this configuration, it is preferable for the inlet port, the outlet port, and the air vent to be provided to the fixed body, although details there of are not illustrated. In this embodiment, too, it is possible to form a pressure gradient inside the annular channel 20, and the configuration of the deaeration device 100 can be simplified, in the same manner as in the first embodiment.

Although the embodiments of the present invention have been described so far, any change, addition, or omission may be made in the configuration within the scope of the present invention.

Although the pressure difference sensor 6 (see FIG. 1) is not illustrated in the second and subsequent embodiments, the liquid surface may also be controlled in the second and subsequent embodiments, in the same manner as in the first embodiment. It has been described that the liquid surface is controlled by controlling the flow rate at which the feeder pump S discharges the fluid, but it is also possible to control the rotational speed of the rotating body, in addition to or instead of the flow rate of the feeder pump 5.

Furthermore, at least one of the inner peripheral surface of the outer peripheral portion 13 and the outer peripheral surface of the inner peripheral portion 12 does not need to be a perfect circle, and may be an elliptical shape, for example. The position of the inlet port 21 is neither limited to the position opposite to the partition 16, nor to the circumferential center of the annular channel 20, and may be changed as appropriate. The feeder pump 5 may be outside of the scope of the deaeration device 100. In such a case, the controller 7 may transmit the estimation result of the liquid surface to another controller that controls the feeder pump 5. The controller 7 may then control the rotation speed of the rotating body for controlling the liquid surface, on the basis of the estimation result of the liquid surface.

In the above embodiment, it has been described that at least one section out of the inner peripheral portion 12, the outer peripheral portion 13, and the side walls 14, 15 is driven in rotation, while the other sections are not driven in rotation; however, all of these sections may be driven in rotation.

The diameter of the inner peripheral surface of the outer peripheral portion 13 or the outer peripheral surface of the inner peripheral portion 12 may be configured to be variable. In the deaeration device 100, the single inner member 11a is housed inside the outer members 11b, 11c during the use, but the deaeration device may include a plurality of inner members 11a that are replaceably mounted on the outer members 11b, 11c, while in the market. The plurality of inner members 11a have diameters different from one another. By selecting one of the plurality of inner members 11a on the basis of the nature of the fluid F to be handled, and mounting the selected one on the outer members 11b, 11c, the channel width of the annular channel 20 can be set to a value suitable for the fluid F. In this case, because the height requirement of the partition 16 also changes, it is preferable to prepare a plurality of partitions 16 having different heights, similarly to the inner member 11a.

For example, when the fluid is highly viscous, it is possible to reduce the torque by increasing the channel width. When the fluid is a pseudoplastic fluid, because the fluid only in the immediate vicinity of the rotating body moves, the channel width may be reduced, so that the fluid flows smoothly inside the annular channel 20.

### REFERENCE SIGNS LIST

100 deaeration device
1 dispensing system
2 tank
3 dispensing unit
4 feed channel
4a dispensing line
5 feeder pump
5a dispensing port
6 pressure difference sensor
6a first pressure sensor
6b second pressure sensor
7 controller
10 deaerator
11 channel forming member
11a inner member
11b first outer member
11c second outer member
11d first member
11e second member
12 inner peripheral portion
13 outer peripheral portion
14 first side wall
15 second side wall
16 partition
16a first surface
16b second surface
16p projecting end
17 transmission shaft
20 annular channel
20a first end
20b second end
21 inlet port
22 outlet port
23 air vent
29 actuator
A air bubbles
C central axis
F fluid

1. A deaeration device comprising:
an annular channel through which a fluid flows;
a channel forming member that has an inner peripheral portion forming an inner peripheral side of the annular channel, an outer peripheral portion forming an outer peripheral side of the annular channel, and a pair of side walls forming respective axial sides of the annular channel, and that defines the annular channel;
an inlet port that is provided to the channel forming member, that opens to the annular channel, and through which the fluid flows into the annular channel;
an outlet port that is provided to the channel forming member, that opens to the annular channel, and through which the fluid flows out of the annular channel;
a partition that is provided to the channel forming member and that partially partitions the annular channel;
an actuator that causes at least one of the inner peripheral portion, the outer peripheral portion, and the pair of side walls to rotate relatively to the partition, in a circumferential direction of the annular channel, to form a gradient in pressure of the fluid in the annular channel; and
an air vent that is provided to the channel forming member, that opens to the annular channel at a position where a pressure of the fluid is lower than the pressure of the fluid in the outlet port, and that releases air bubbles contained in the fluid, to outside of the annular channel.

2. The deaeration device according to claim 1, wherein the outlet port opens to an end on a high-pressure side of the annular channel, the high-pressure side being defined by the partition, and the air vent opens to an end on a low-pressure side of the annular channel, the low-pressure side being on an opposite side of the high-pressure side with respect to the partition.

3. The deaeration device according to claim 1 or 2, wherein the inlet port opens to the annular channel at a position where the pressure of the fluid is lower than the pressure of the fluid in the outlet port, and where the pressure of the fluid is higher than the pressure of the fluid at the air vent.

4. The deaeration device according to claim 1, wherein the inlet port and the outlet port are separated from each other in an axial direction of the annular channel.

5. The deaeration device according to claim 1, further comprising:
a pressure difference sensor that detects a difference in the pressure of the fluid between two different points in a circumferential direction of the annular channel; and
a controller that estimates a position of a liquid surface inside the annular channel based on the detected difference in the pressure.

6. The deaeration device according to claim 1, wherein the channel forming member includes an inner member that forms the inner peripheral portion, a first outer member that is separate from the inner member and that forms the outer peripheral portion and one of the pair of side walls, and a second outer member that forms remaining one of the pair of side walls.

7. The deaeration device according to claim 6, wherein
the inner member is a rotating body that is driven in rotation by the actuator, and each of the first outer member and the second outer member is a fixed body that is not driven in rotation by the actuator, and
the partition as well as the inlet port, the outlet port, and the air vent are provided to the fixed body.

8. The deaeration device according to claim 6, wherein
the inner member is a rotating body that is driven in rotation by the actuator, and each of the first outer member and the second outer member is a fixed body that is not driven in rotation by the actuator, and
the partition as well as the inlet port, the outlet port, and the air vent are provided to the rotating body.

9. The deaeration device according to claim 6, wherein
the first outer member and the second outer member are rotating bodies that are driven in rotation by the actuator, and the inner member is a fixed body that is not driven in rotation by the actuator, and
the partition as well as the inlet port, the outlet port, and the air vent are provided to the fixed body.

10. The deaeration device according to claim 6, wherein
the second outer member is a rotating body that is driven in rotation by the actuator, and the inner member and the first outer member together form a fixed body that is not driven in rotation by the actuator, and
the partition as well as the inlet port, the outlet port, and the air vent are provided to the rotating body.

11. The deaeration device according to claim 1, wherein
the channel forming member includes a first member that forms the inner peripheral portion, one of the pair of side walls, and the outer peripheral portion, and a second member forming remaining one of the pair of side walls,
the second member is a rotating body that is driven in rotation by the actuator, and the first member is a fixed body that is not driven in rotation by the actuator, and
the partition as well as the inlet port, the outlet port, and the air vent are provided to the rotating body.
